(19) United States
(12) Patent Application Publication
(10) Pub. No.: US 2005/0172540 A1
(43) Pub. Date: Aug. 11, 2005

(54) Protected fishing leader and line and method of making

(76) Inventor: James Allen Mizen, Tiffen, OH (US)

Correspondence Address: John H. Miller, 29666 Chatham Way, Perrysburg, OH, 43551, US

(21) Appl. No.: 11/042,675

(22) Filed: Jan. 25, 2005

Related U.S. Application Data
(60) Provisional application No. 60/542,899, filed on Feb. 10, 2004.

(51) Int. Cl. A01K 91/04; A01K 91/00

(52) U.S. Cl. 43/44.98; 43/44.84

(57) ABSTRACT

A non-metallic fishing leader or line having a vulnerable length of the leader or line protected by, and in close proximity with, an interior surface of one or more, separate protective item(s) is disclosed and a method of making the protected leader or line. The leader or line is protected by one or more lengths of flexible plastic tubing, or by a plurality of beads. Also disclosed are some fishing rigs using this type of leader. The protected fishing leader or line has good “feel” and “bait action” compared to existing metal or tapered leaders.

This application is a continuation-in-part of a Provisional Application No. 60/542,899 filed Feb. 10, 2004. The invention involves guarded or protected fishing leaders and a method of making the guarded leaders.

Fishing leaders connect one or more fishing hooks to a fishing line and are used to protect the fishing line from damage and breaking from rocks, debris, and fish mouths. Leaders typically comprise a length of braided multi-filament or monofilament wire, and typically have a means on one end permitting rapid and easy connection to a fishhook or lure. Metal leaders are used because of their high strength and durability, but it is well known that metal leaders do not provide the best “feel” of the lure or bait desired by fishermen, and do not provide the best “bait action” most desired by most experienced fishermen. One shortcoming is that rigs containing one or more of these leaders cannot be easily or quickly taken apart to change or fix. When other material is used in place of the wire, the life is much shorter and the risk of loosing a big fish is significantly increased.

When fishing line is used without a leader, or when leaders of multifilament or monofilament synthetic material, like nylon, are used they provide short life and sometimes cause loss of a big fish due to wear of the leader by rubbing on rocks, etc. or fishes mouths. Therefore, a fisherman must compromise either “bait action” and “feel”, or both, by using a metal leader or risk fish loss by either not using a leader or by using a monofilament or multifilament line of a synthetic polymer like nylon, etc. The invention provides the advantages of a leader while also providing the desired “bait action” and “feel” and the durability and strength needed to avoid most fish loss due to leader failure.

The invention comprises a fishing leader having a vulnerable length section, the vulnerable length section being defined as that portion of the length that is vulnerable to being abraded by fish mouths, rocks, debris located on the bottom of seas, lakes, rivers, ponds, or other bodies of water, the vulnerable length section being surrounded by one or more protective articles to prevent abrasion of the leader or to prevent the leader from failing from being bitten by fish. The leader can typically have a loop on each end of the leader material, but more typically has a loop on one end and either a fishhook, including a snelled hook or a quick disconnect device on the other end. A snelled hook is a fishhook that is attached to a fishing line or other leader material in a known permanent manner such as with a smooth know, braiding, or other known means.

The article or articles that protect the leader material comprise one or more protective tubes, beads or other shapes. The vulnerable length section of the line or leader will vary with the size of the fish sought after. For lake perch, the vulnerable length will extend from about one to about 7 inches from where a fishhook is attached to the line or leader, or from a leader or line end of a quick release device used to connect the line or leader to the fishhook. When fishing for larger fish, such as Northern Pike, or Barracuda, the vulnerable length can extend even further, such as up to 12 or even 18 inches or more. If still larger fish are sought, the vulnerable length will be even longer, as much as 36 inches or more.

Typically a tubular protector, in one or more sections, is used to protect the vulnerable portion of a fishing leader or line close to a hook, the line or leader being a monofilament or multi-filaments of non-metallic, synthetic or natural material. Optionally, one or more snap swivels or barrel swivels can be used to attach the leader according to the invention, attaching to a loop on the end of the leader, to a fishing line to enable fast and easy changes from one leader to another or one fishing rig to another.

According to the invention, one or more flexible, non-metallic, tubes, beads, or other items surround the leader line in a vulnerable zone adjacent to one or more hooks, or hook/lure attachment device, to protect the leader or line from abrasion or severing action. An interior surface of the flexible tube, tubular protector(s), beads or other protective item(s) is in close proximity to the exterior surface of the leader or line to provide the “feel” and “bait action” similar to an unprotected line or leader of non-metallic natural or polymeric material and superior to that of a metal leader, the “feel” and “bait action” most desired by fishermen. By close proximity is meant that the distance between the interior diameter (I.D.) of the tube, or hole in other protective shapes, and the outer surface of the line or leader material is not more than about 0.17 inch, typically not more than about 0.09 inch, more typically not more than about 0.07 inch, still more typically not more than about 0.05 inch and most typically not more than about 0.03 inch and can be as little as zero. Typically there is a slight gap between the outer surface of the leader material and the interior of the protective tube or bead to enable threading the leader material through the protective article with a needle or equivalent device and to enhance “feel” and “bait action”. Typically, this gap will be at least 0.003 inch, more typically at least about 0.007 inch and most typically at least about 0.01 inch, however if the tubing is heat shrunk after threading no gap is necessary.

The outside diameter of the protective tube bead should be as small as possible, so long as the protective function is provided, to provide the best “bait action” and “feel”, and in some cases, so it is harder for the fish to see the guard. The wall thickness of the protective article should not exceed 0.1 inch, typically is less than about 0.07 inch, more typically is less than about 0.05 inch and most typically is less than about 0.04 inch. Typical materials for non-metallic lines and leaders for use in the invention include nylon, cotton, rayon, and high strength polymers other than nylon.

Metallic or non-metallic beads can also be used to protect the vulnerable portion of a line or leader. If metallic, the beads are usually hollow to reduce weight, but solid metal beads, having a hole therethrough for the line or leader are also suitable. More typically the beads used to protect the line or leader are glass or a plastic, a polymer. The beads can be spherical, oval, elongated or other shapes, and colored beads are particularly suitable. Bright colors attract fish so bright colored beads are particularly desirable. The diameter of the hole through the protective beads is in close proximity to the outer surface of the vulnerable length of the line or leader.

An optional feature of the invention is to use a transparent protective tube, bead or other shape with a colored leader or line, or a colored protective article to attract a particular kind of fish and/or to more easily identify specific set-ups. This is a very desirable optional feature to both retail displays and attractiveness to both the fisherman and at least some fish.

A tubular protector is a tough, flexible, material that resists abrasion from rocks, fishes mouths, etc., resists being bit through, while also providing the “bait action” and “feel” that fishermen desire. Materials typically used for the tubular protector include nylon, natural rubber, TYGON®, polyethylene, Teflon®, polypropylene, and other materials having similar strength and flexibility. A typical tubular protector of TYGON® has an I.D. of 1/32 inch, an O. D. of 3/32 inch and a wall thickness of 1/32 inch, but many other size tubular protectors can be used as will be described below. The invention also comprises many optional features that will be described below and methods of making a protected leader line.

The invention comprises a tubular protector for a portion of fishing line close to a hook, or for a leader line of monofilament or multifilament of non-metallic, synthetic or natural material. An optional feature of the invention is to use a colored leader or a colored tubular material to readily identify specific set-ups. The tubular protector is a tough, flexible, material that resists abrasion from rocks, fishes mouths, etc., resists being bit through, while also providing the “bait action” and “feel” that fishermen desire. Materials typically used for the tubular protector include nylon, TYLON®, polypropylene, Synflex®, Cobra®, polyethylene (particularly medium density), Teflon®, polypropylene, silicone, plasticized, transparent polyvinyl chloride and other materials having similar strength and flexibility. A typical tubular protector of TYGON® has an I.D. of 1/32 inch, an O. D. of 3/32 inch and a wall thickness of 1/32 inch, but many other size tubular protectors can be used as will be described below. The invention also comprises many optional features that will be described below.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

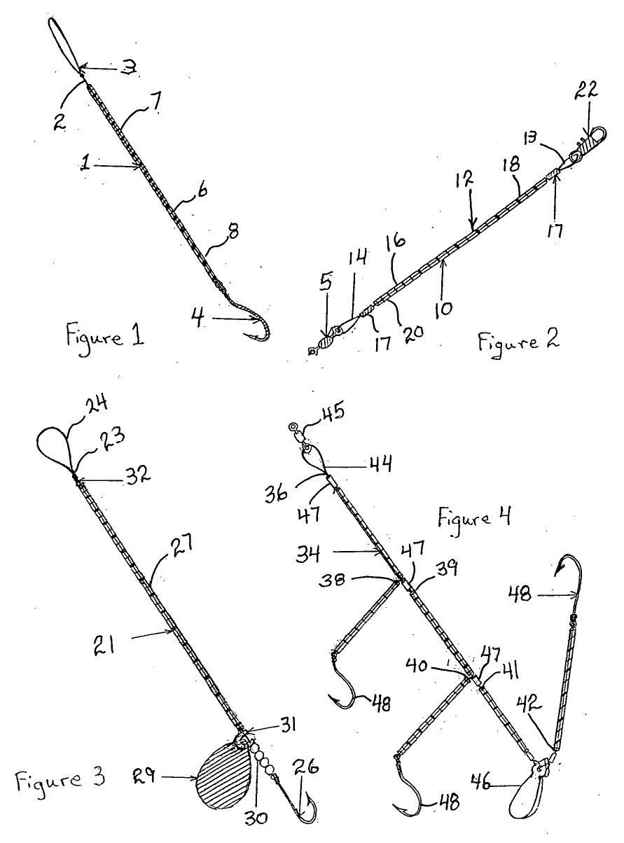

FIG. 1 is a perspective view of fishing set-up comprising a tubular protector for a leader according to the invention.

FIG. 2 is a perspective view of another embodiment fishing set-up comprising a tubular protector for a leader according to the invention.

FIG. 3 is a perspective view of still another embodiment of a fishing set-up comprising a tubular protector for a leader according to the invention.

FIG. 4 is a perspective view of yet another embodiment of a fishing set-up comprising a tubular protector for a leader having two or more hooks according to the invention.

FIG. 1 shows a simple fishing set-up 1 according to the invention comprising a leader 2 with a loop 3 on one end for attaching the leader 2 to a fishing line directly or with a quick release device such as a snap swivel, barrel swivel or other quick release device. The other end of the leader 2 is tied to a conventional hook 4. The leader 2 is surrounded with a flexible protective tube 6 to protect the leader from abrasion from rocks, fish mouths and other objects such as limbs, logs, debris on the bottom, etc. The length of this guarded leader embodiment is typically about 8-8.5 inches, but the length is a matter of choices and preference. The protective tube 6 is typically a single piece, but can alternatively comprise two or more sections 7,8 to improve flexibility. The protective tube 6 should extend from the eye of the hook up the leader 2 for a sufficient distance to protect the leader 2 in its most vulnerable segment which is typically about 1 inch to about 20 inches from the eye of the hook to the knot or other means securing the loop 3, more typically up to about 12 inches and most typically up to about 7 inches, with many being up to about 5-6 inches. However, on deep sea, fishing rigs, such as used for Grouper, the vulnerable and protected length can be up to 48 inches or more. A typical tubular material useful for the protective tube 6 is a product called TYGON®, A

FIG. 2 shows another fishing set-up according to the invention. In this set-up 10, which can be of any desired length, a leader 12 has loops 13, 14 on each end and a protective flexible tube 16, according to the present invention, surrounding a substantial length of the leader 12 between the loops 13 and 14. Each end of the leader 12 can be wrapped on around a non-loop portion of the leader 12 one or more times, see 17, and secured with a knot, fusion of the leader wrap 17 or an adhesive in a known manner to secure the loops 13, 14. A short metal or plastic crimped tube can also be used at 17 to secure the loops 13 and 14. Again, the flexible protective tube 16 can be in one piece or made up of two or more sections 18, 19 and surrounds a leader. This set-up 10 has an optional conventional quick disconnect device, such as an interlocking snap connector 22 attached to the loop 13 and an optional different conventional quick release device attached to the other loop 14 of the leader 12, such as a barrel swivel or a barrel swivel 5 or other conventional connecting device.

FIG. 3 shows a different fishing set-up according to the invention. This set-up 21 comprises a leader 23 having a loop 24 on one end and a hook 26 attached to the other end, a protective flexible tube 27 according to the invention surrounding at least a substantial portion, typically at least most of a vulnerable length of the leader 22. This set-up 21 optionally comprises a conventional spinner 29 and several conventional spacer beads 30. The leader 22 runs through a clevis 31 attached to the spinner 29. An end of the leader 22 forming the loop 24 is wrapped around the leader 22 to form a wrap securement 32 as described in the previous paragraph.

FIG. 4 is another fishing set-up embodiment that can be of any length. The specific embodiment shown here is about 31 inches long, according to the invention and can be used to catch any kind of fish. It is particularly good for Great Lake Perch. This set-up 34 is a multi-hook set-up with the hooks 48 spaced apart. In the set-up 34, the protected leader according to the invention is in 4 or more sections that are labeled 36, 38, 39 40, 41 and 42. The leader section 36 can be made using a single non-metallic leader line, comprising sections 36, 39 and 41, or can be divided into three separate sections 36, 39 and 41 with sections 38, 40, and 42 connected in any suitable manner such as a knot or more typically with conventional crimped tubing sections 47 shown here. Also, crimpable metal or plastic tubing sections 47, different than the tubing sections 36, 39 and 41, can be used in a known manner to secure the various splices or knots holding the protected leader sections together. A loop 44, made from the non-metallic leader line is at the front end of the protected leader 34 to facilitate attaching to a fishing line or an optional connector such as a barrel swivel 45.

The sections 36, 38, 39, 40, 41 and 42 of the rig 34 can be connected directly together or can have an optional item therebetween, such as a sinker 46, or alternatively a quick disconnect device like a snap or barrel swivel, shown here between sections 41 and 42. The protectors covering the leader in sections 36, 38, 39, 40, 41, and 42 can be single pieces of flexible tubing or multiple pieces of flexible tubing, rigid tubing, beads or other protective items so long as they provide the flexibility and protection for the leader or line. Most typically, single pieces of flexible tubing, transparent, colored, striped or otherwise decorated, are used to protect the leader sections or line sections. The end of each leader section or line section is attached to a hook 48 in any suitable manner.

In the invention, including the above described embodiments, the leaders can be colorless, transparent, or more typically are a color. Any color is suitable, but bright colors and even iridescent colors are suitable. Colored monofilament or multi-filament strands that can be used to make leaders are well known. Also, instead of the leader being colored, the flexible protective tube can be colored by including a coloring agent in the polymer material the tube is made of or by coating the tubing in a known manner, either completely, on one or both surfaces, or partially as with stripes, dots, etc.

When beads, or short tubular pieces, having a hole therethrough are used to protect the leader or line, any reasonable size and any color or transparent can be used, but most typically they should be as small as practical to maintain the flexibility, “bait action” and “feel” most desired by both fish and fisherman.

As used herein, the “vulnerable length or portion” or the leader or fishing line is that portion or length adjacent the fishhook, or connecting device used to attach the fishhook to the leader or fishing line, that is normally subject to damage and severing, with or without stress from a fish on the hook, due to abrasion from fish, rocks and/or debris in the water and from damage from the fishes mouth. To achieve the “feel” by the fisherman, and the “bait action” desired by fishermen, it is important that the protective tube or other protective items have an interior opening therein through which the leader or fishing line passes and that the surface of the opening needs to be in “close proximity” to the surface of the leader or fishing line.

Also important to the good “feel” and the “bait action” of the present invention is the flexibility of the protective item or, when two or more protective items are used in series as the protection, the flexibility of the plurality of protective items, when it is, or they are, in place on the fishing set-up of the invention. The best results are achieved when a 3/32 inch OD TYGON® R-3603 AAC0001 tubing available from Saint-Gobain Performance Plastics in Akron, Ohio, is most typically used with a monofilament line having an OD of about 0.0185 inch (25 lb. line), or a monofilament line having an OD of about 0.23 inch (30 lb. line). The 25 lb. test line was a Berkiey Ironsilk™ line having a diameter of about 0.0185 and the 30 lb. test line was a Shakespeare Omniflex™ monofilament line having a diameter of about 0.023 inch. Also, a 17 lb. test line, Vanish™, from Berkiey, a fluorocarbon monofilament line having a diameter of about 0.015 inch, can be used for smaller fish. Any line, monofilament or multifilament, will work in the invention as long as its OD is not larger than the ID of the tubing. Heavier line, higher test strength, used for larger fish and heavier line normally requires using a larger diameter protective item.

Even rigid tubing can be used when divided into a plurality of short sections and used in series to provide the protection. Soft or rigid beads or other protective items can be used in series because the flexibility of the individual beads, tube sections, or other items is not critical. By the term “beads” is meant any exterior shape of bead having a hole therein that a leader or fishing line can pass through in close proximity to the surface of the hole and wherein a plurality of beads protects the vulnerable length of the leader or fishing line. While a plurality of tubular sections, beads, or mixtures thereof are useable in the practice of the invention, it is most desirable to use as long of length(s) of flexible tubing as practical to protect the vulnerable length of the leader or fishing line.

The R-3603 tubing has a Durometer Hardness Shore A, 15 sec. Of about 55, an elongation (ASTM D 412-98) of about 450, a water absorption (ASTM D 570-98) of about 0.24 and a brittleness by impact (ASTM D 746-98) of about minus 58 degrees F., but other tubing having a range of sizes and properties are also useful in the invention. Tubing having a greater flexibility is useful in the invention so long as the “close proximity” requirements described above are met. Less flexible tubing can be used and substantially less flexible tubing can be used on large fish set-ups where the flexibility of the tubing is not as critical due to the weight of the hook(s), bait and other items attached to the hook or connector. For 35 to 80 lb. test leader or line, a tubing having an O.D. of about 3/32 inch and an I.D. of about 1/32 inch, wall of about 1/32 inch, is used. For stronger line, such as up to 100 lb. test line or leader, a larger tube is normally used such as tubing having an O.D. of about 1/8 inch, an I.D. of about 1/16 inch and a wall thickness of about 1/32 inch or thicker.

The leaders of the invention can be made by several methods. Typically the leader line is put through the protective tubing by first lubricating the interior of the tubing, the leader line or both with water, soapy water or other lubricant, and then pushing the leader line through the tubing or other protector. Another method is to connect the monofilament or multi-filament line to a needle having a diameter smaller than the ID of the tubing and a length longer than the tubing and then push and pull the needle through the length of tubing. The line can be connected to the needle in any known manner, and the leading end of the needle need not be sharp, can even be blunt, but a tapered leading end is easier to use. Also, to aid threading of the line or leader through the tubing, a heat shrinkable tubing can be used and after threading the tubing can be heated in a known manner to shrink the inside surface of the tubing into “close proximity” or even into contact with the exterior of the line or leader. After threading, the line is connected to other parts of the rig in a known manner, but one end of the leader line can be connected to another member of the rig before threading if desired. Also, one end of the leader line can be formed into a loop, such as 24 in FIG. 3, before threading if desired.

Many embodiments and modifications of the invention are described above in detail and from this disclosure many further embodiments and modifications will be obvious to one having ordinary skill in this art. Those embodiments and obvious modifications are intended to be included within the scope of the following claims.

1. A fishing leader comprising a non-metallic leader line having a vulnerable length of the leader line protected by, and in close proximity with, an interior surface of one or more, protective item(s), the fishing leader providing good “feel” and “bait action”.

2. The fishing leader of claim 1 wherein the protective item(s) is one or more lengths of flexible plastic tubing.

3. The fishing leader of claim 2 wherein the distance between the surface of the leader or line and the interior surface of the flexible tubing is no more than about 0.09 inch.

4. The fishing leader of claim 1 wherein the distance between the surface of the leader or line and the interior surface of the protective item(s) is no more than about 0.17 inch.

5. The fishing leader of claim 3 wherein the wall thickness of the flexible tubing is about 0.03 inch.

6. The fishing leader of claim 2 wherein the flexible tubing is transparent.

6. The fishing leader of claim 6 wherein the leader line is a bright color.

7. The fishing leader of claim 2 wherein the flexible tubing is a bright color.

8. The fishing leader of claim 1 wherein the protective items are beads.

9. A fishing set-up for attaching to a fishing line, the set-up comprising at least two spaced apart hooks and at least two spaced apart non-metallic leader lines for supporting said hooks, each of the leader lines being protected by, and in close proximity with an interior surface of, one or more protective item(s), each protected non-metallic leader line providing good “feel” and “bait action”.

10. The set-up of claim 9 wherein each of the leaders lines is protected with one or more lengths of flexible plastic tubing.

11. The set-up of claim 10 wherein the distance between the surface of the leader line and the interior surface of the flexible tubing is no more than about 0.09 inch.

12. The set-up of claim 9 wherein the distance between the surface of the leader or line and the interior surface of the protective item(s) is no more than about 0.17 inch.

13. The set-up of claim 11 wherein the wall thickness of the flexible tubing is about 0.03 inch.

14. The set-up of claim 10 wherein the flexible tubing is transparent.

15. The set-up of claim 14 wherein the leader line is a colored.

16. The set-up of claim 10 wherein the flexible tubing is a colored.

17. The set-up of claim 9 wherein the protective items are beads.

18. A method of making a non-metallic fishing leader having a vulnerable length of leader line protected by, and in close proximity with, an interior surface of one or more, protective item(s), the protected fishing leader providing good “feel” and “bait action”, comprising,
a) threading a vulnerable length of the leader line through a opening through one or more protective items, the opening forming the interior surface, and
c) forming a loop on one or both ends of the leader line.

19. The method of claim 18 wherein the protective item is one or more lengths of flexible plastic tubing.

20. The method of claim 19 wherein the distance between the surface of the leader line and the interior surface of the flexible tubing is no more than about 0.09 inch.
